(19) United States
(12) Patent Application Publication
(10) Pub. No.: US 2016/0046109 A1
(43) Pub. Date: Feb. 18, 2016

(54) PRODUCTION EQUIPMENT FOR CORRUGATED PAPER

(71) Applicant: Tzu-Che LIN, Taoyuan County (TW)

(72) Inventor: Tzu-Che LIN, Taoyuan County (TW)

(21) Appl. No.: 14/818,966

(22) Filed: Aug. 5, 2015

(30) Foreign Application Priority Data
Aug. 12, 2014 (TW) 103214327

(51) Int. Cl. B32B 37/00; B31F 5/04

(52) U.S. Cl. CPC B32B 37/0053; B31F 5/04; B32B 37/0076

(57) ABSTRACT

A production equipment for corrugated paper comprises a bonding device having a base, and a guiding assembly is installed in base and a driving mechanism is installed adjacent to guiding assembly, in which space is created between driving mechanism and guiding assembly for mutually squeezing and bonding glue layers among lining paper, paper material and sandwiched core-paper to form paper board, and bonding device is configured with a heating tool. A pre-heater capable of heating sandwiched core-paper is installed on input side of base to perform pre-heating to sandwiched core-paper by means of pre-heater before heating lining paper, paper material and sandwiched core-paper in heating tool, so speed for solidifying and bonding between glue layers of paper material and sandwiched core-paper can be effectively accelerated through the temperature contained in itself thereby lessening the number of elements installed in the subsequent heating process and reducing manufacturing costs of corrugated paper.

This application claims the priority benefit of Taiwan patent application number 103214327, filed on Aug. 12, 2014.

### BACKGROUND OF THE INVENTION

1. Field of the Invention

The present invention generally relates to a production equipment for corrugated paper; in particular, it relates to a production equipment for corrugated paper capable of using a pre-heater installed on a input side of a base to perform pre-heating to sandwiched core-paper by means of a pre-heating board of a pre-heater before heating lining paper, paper material and sandwiched core-paper in a heating tool, thereby lowering the configuration costs and power consumption costs for the elements of the heating tool in the later heating process and further reducing the total manufacturing costs of corrugated paper.

2. Description of Related Art

Merchandises are frequently traded in modern world, and corrugated paper boxes are very widely utilized in numerous transfers for goods as well. In addition to light weight and hardness, corrugated paper boxes can also protect the merchandises contained therein by means of its elasticity and shock-proof functions based on the wave-shaped sandwiched core-paper so as to reduce the damages to the goods due to external impact forces. Besides, low manufacturing costs thereof further allow corrugated paper boxes to become the primary option for packages in merchandise transfers.

Typically, the structure of corrugated paper is constituted by a wave-shaped sandwiched core-paper placed between two layers of lining paper.

In fabricating the corrugated paper, a sandwiched core-paper is initially squeezed and pressed by multiple corrugated rollers such that the face on the lower side of the sandwiched core-paper forms a wave-shaped corrugated face, and this corrugated face of the sandwiched core-paper along with a face on the lower side of a lining paper are each applied with a glue layer through a gluing device thereby allowing the two lining papers and the corrugated paper to be squeezed and pressed by multiple rollers in order to make the glue layer on the lower side of the above-said lining paper stick to the non-machined face of the sandwiched core-paper. Meanwhile, the glue layer on the corrugated face of the sandwiched core-paper is attached to the other lining paper, then subsequently using plural heating boards to heat the glue layers between the two lining papers and the sandwiched core-paper for solidification and attachment thus completing the corrugated paper production processes.

However, since the aforementioned plural heating boards can heat only one side of the corrugated paper, the corrugated paper needs to be heated by means of plural heating boards so that heat energy can gradually penetrate through the corrugated paper to heat the glue layers in order to perform solidification and attachment operations on each layers, thus inevitably further causing increased manufacturing costs in corrugated paper production processes due to the installation of plural heating boards.

Accordingly, the issue concerning how to effectively eliminate the increased corrugated paper manufacturing costs caused by installing multiple heating boards in production processes has become one important subject to be ameliorated for relevant vendors in this industry.

### SUMMARY OF THE INVENTION

Therefore, with regards to the above-said issues and flaws, the inventors of the present invention collected related information through various evaluations, considerations and in-field experiences of many years in this industry, along with incessant tests and modifications, and designed the production equipment for corrugated paper of the present invention, which allows the pre-heating operation to the sandwiched core-paper by means of a pre-heater installed on the input side of the base thereby reducing the installation costs for the elements within the heating tool.

The primary objective of the present invention is to install a pre-heater on the input side of the base in order to pre-heat the sandwiched core-paper by means of the pre-heater before the heating tool heats the lining paper, paper material and sandwiched core-paper such that, after squeezing and attaching operations performed on the lining paper, paper material and sandwiched core-paper within a space, it is possible to accelerate the solidification and bonding speed of glue layers applied between the paper material and the sandwiched core-paper through the temperature contained in the sandwiched core-paper itself thus further elevating the machining efficiency and production yields for corrugated paper. Moreover, because of the pre-heating operation performed to the sandwiched core-paper, it is possible to lessen the number of elements installed within the heating tool in the subsequent heating process so as to save installation costs and power consumption costs for certain elements thereby further reducing the total manufacturing costs of corrugated paper.

The secondary objective of the present invention lies in that an L-shaped swing arm is installed to the pre-heater on the other side opposite to the pre-heating board, an axis portion pivotally connected for the swing arm to turn and bend is installed on one side of the base adjacent to the pre-heater, a driving portion is installed over the base, and the driving portion has a retractable rod connected to the swing arm. As such, the present invention in practice allows to drive the retractable rod to stretch or retract via the driving portion in order to drive the swing arm to rotate around the axis portion as an axial center thereby bringing the pre-heating board of the pre-heater away from the non-machined face of the sandwiched core-paper to facilitate convenient sandwiched core-paper replenishment or alternation operations for handy operations.

### BRIEF DESCRIPTION OF THE DRAWINGS

FIG. 1 shows a lateral cross-section view for a first embodiment of the present invention.

FIG. 2 shows a lateral cross-section view for a second embodiment of the present invention.

FIG. 3 shows an action status view for the second embodiment of the present invention.

### DETAILED DESCRIPTION OF THE PREFERRED EMBODIMENTS

To achieve the aforementioned objective and effects, with regards to the technical means and structures utilized in the present invention, the characteristics and functions thereof will be hereunder set forth by the details descriptions concerning the preferred embodiments of the present invention along with appended drawings in order to comprehensively understand the present invention.

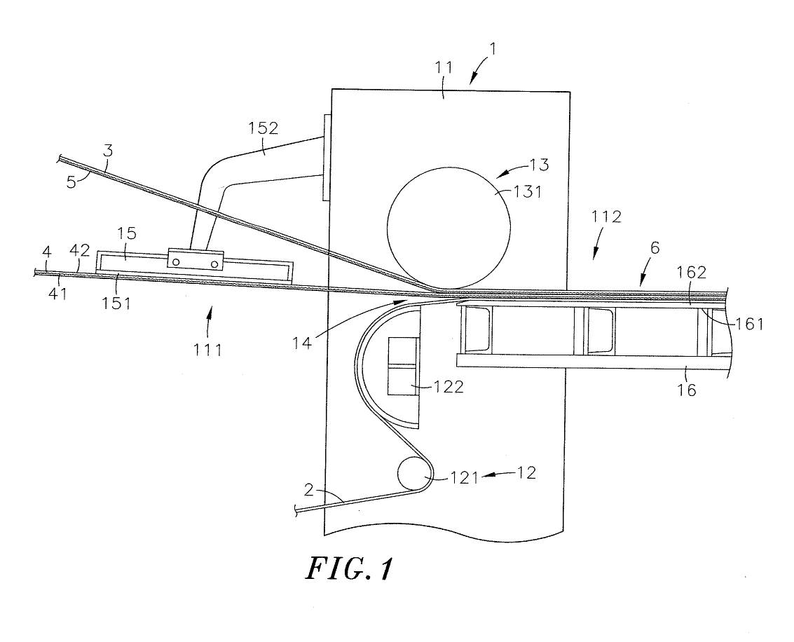

Please refer to FIG. 1, wherein a lateral cross-section view for a first embodiment of the present invention is shown. It can be clearly seen from the Figure that the production equipment for corrugated paper according to the present invention comprises a bonding device 1 including a base 11, and a guiding assembly 12 is installed in the base 11. The guiding assembly 12 includes a passive roller 121, and a guiding portion 122 is installed over the passive roller 121. Furthermore, a driving mechanism 13 is installed adjacent to the guiding assembly 12, and the space 14 is formed between the driving mechanism 13 and the guiding assembly 12. Besides, the driving mechanism 13 has a pressing roller 131, and the space 14 is formed between the guiding portion 122 and the pressing roller 131. Also, a pre-heater 15 is placed on a input side 111 of the base 11, while a heating tool 16 is set up on an output side 112 of the base 11. On one side of the pre-heater 15 there forms a pre-heating board 151, and a suspension arm 152 connected to the base 11 is set up on the other side opposite to the pre-heating board 151. The heating tool 16 has a heating platform 161, and a plurality of backward adjacently arranged heating boards 162 are installed on the surface of the heating platform 161.

Upon using the present invention in practice, lining paper 2 can be attached to the passive roller 121 of the guiding assembly 12 and then enters into the space 14 under the guidance of the guiding portion 122. The face on the lower side of a paper material 3 is applied with a glue layer 5 by means of a front-end gluing device (not shown in Figure); meanwhile, the face on the lower side of a sandwiched core-paper 4 is squeezed and pressed to form a corrugated face 41 by means of a front-end corrugated roller set (not shown in Figure), and the corrugated face 41 of the sandwiched core-paper 4 is also applied with the glue layer 5 by means of the gluing device. Additionally, the pre-heating board 151 of the pre-heater 15 is engaged with a non-machined face 42 of the sandwiched core-paper 4 such that heat energy from the pre-heater 15 can perform the pre-heating operation on the sandwiched core-paper 4. Herein the paper material 3 and the sandwiched core-paper 4 are sequentially overlapped on top of the lining paper 2 and pressed by the pressing roller 131 such that the lining paper 2, paper material 3 and sandwiched core-paper 4 can be transferred toward the space 14 through the rotations of the pressing roller 131, and in this way, the glue layer 5 on the lower surface of the paper material 3 can be squeezed and attached to the non-machined face 42 on one side of the sandwiched core-paper 4, while the glue layer 5 of the corrugated face 42 on the other side of the sandwiched core-paper 4 can be pressed down and attached to the upper surface of the lining paper 2 thereby allowing the glue layers 5 between the lining paper 2, paper material 3 and sandwiched core-paper 4 to be mutually squeezed and bonded in the space 14 to form a paper board 6. Following this, by using a plurality of heating boards 162 in the heating platform 161, it is possible to heat the glue layers 5 on the lower side of the paper material 3 to be solidified and bonded to the non-machined face 42 of the sandwiched core-paper 4 and also to heat the glue layers 5 on the corrugated face 41 of the sandwiched core-paper 4 to be solidified and bonded to the upper side of the lining paper 2 so as to solidify the glue layers 5 in the paper board 6 thus completing the bonding operation of the lining paper 2, paper material 3 and sandwiched core-paper 4.

The aforementioned guiding assembly 12 and driving mechanism 13 can operate conjunctively with their transfer front-end and transfer back-end roller sets (not shown in Figure) so as to perform transfer operations on the lining paper 2, paper material 3 and sandwiched core-paper 4; however, above-said roller sets are common in the art, and details thereof are not critical for the constitution of the present invention thus herein omitted for brevity.

The aforementioned paper material 3 can be replaced by another lining paper or another sandwiched core-paper as well. In case the paper material 3 is replaced by another lining paper, then, after completing the bonding operation to the lining paper 2, paper material 3 and sandwiched core-paper 4, the paper board 6 becomes a single-layered corrugated paper (i.e., corrugated paper having single-layered sandwiched core-paper); on the other hand, suppose the paper material 3 is replaced by another sandwiched core-paper, then the glue layer may be attached to the corrugated face on the lower side of the paper material 3, thus after completing the bonding operation to the lining paper 2, paper material 3 and sandwiched core-paper 4, the paper board 6 can be further processed by a tooling machine (not shown in Figure) located at the back-end of the heating tool 16 to attach another lining paper of the exterior layer to the face on the upper side of the paper material 3 thereby forming a double-layered corrugated paper (i.e., corrugated paper having double-layered sandwiched core-paper.)

The bonding device 1 according to the present invention comprises the pre-heater 15 installed on input side 111 of the base 11 in order to perform the pre-heating operation to the sandwiched core-paper 4 before the plural heating boards 162 of the heating tool 16 heat the lining paper 2, paper material 3 and sandwiched core-paper 4 such that, after the lining paper 2, paper material 3 and sandwiched core-paper 4 have been squeezed and bonded in the space 14, the speed of solidification and attachment on the glue layers 5 of the paper material 3 and the sandwiched core-paper 4 can be accelerated through the temperature contained in itself thereby elevating the machining efficiency for corrugated paper productions. Moreover, because of the pre-heating operation performed to the sandwiched core-paper 4 by the pre-heater 15, it is possible to lessen the number of elements installed within the heating tool 16 (i.e., the number of installed heating boards 162) in the subsequent heating process so as to save installation costs and power consumption costs for certain elements thereby further reducing the total manufacturing costs of corrugated paper.

The pre-heating operation performed to the sandwiched core-paper 4 as previously set forth illustrates simply a preferred embodiment of the present invention; the present invention may be also applied to manufacturing operations designed for double-layered, triple-layered or four-layered corrugated paper in which it requires only to configure multiple pre-heaters 15 thereby performing pre-heating operations to each layer of the corrugated paper 4, and accordingly the scope of the present invention is by no means limited thereto. As such, it should be noticed that other modifications and equivalently structural alternations are all included within the scope of the present invention.

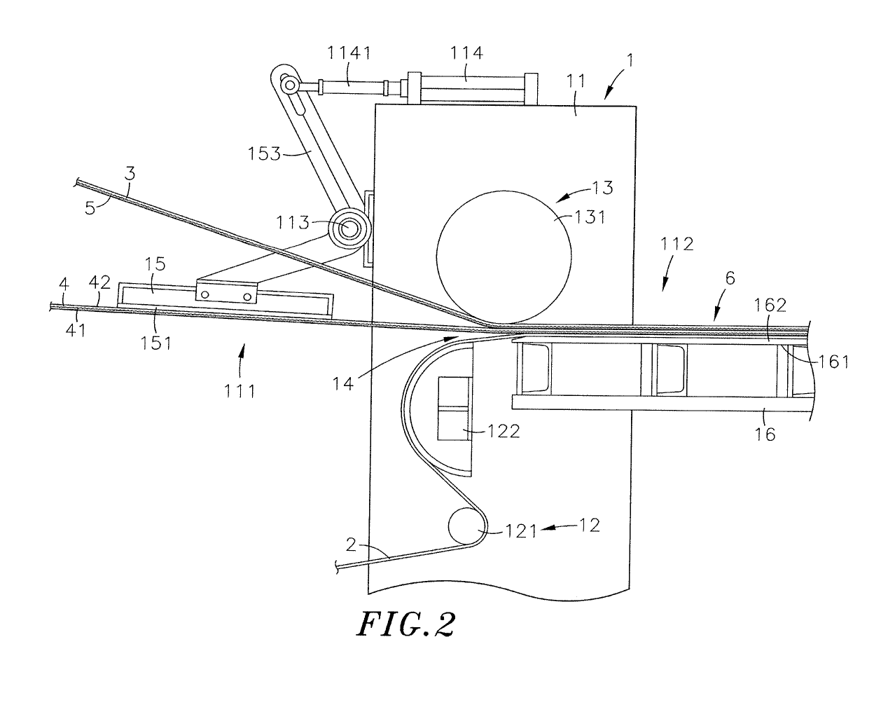

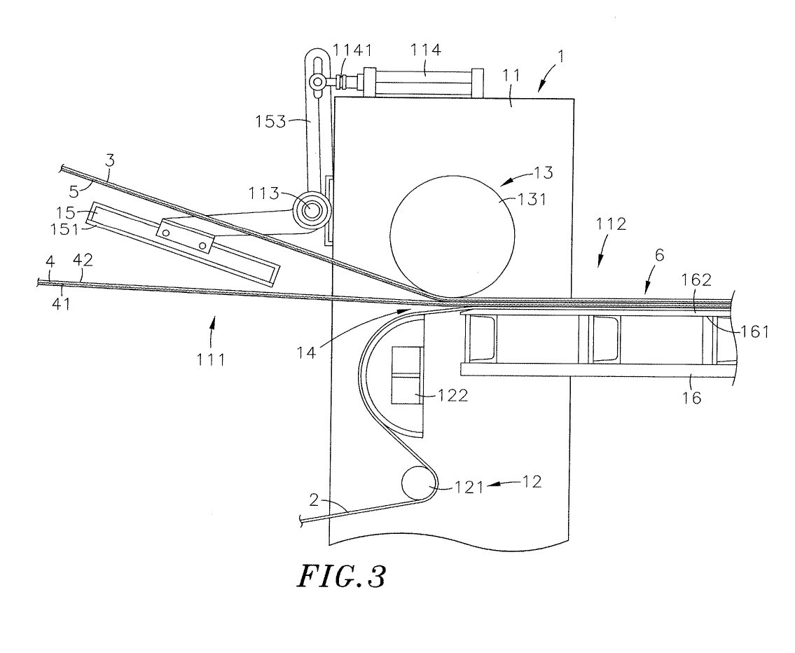

Please refer to FIGS. 2 and 3, wherein a lateral cross-section view and an action status view for a second embodiment of the present invention are shown. It can be clearly observed from Figures that an L-shaped swing arm 153 is installed to the aforementioned pre-heater 15 on the other side opposite to the pre-heating board 151, an axis portion 113 pivotally connected for the swing arm 153 to turn and bend is installed on one side of the base 11 adjacent to the pre-heater 15, a driving portion 114 is installed over the base 11, and the driving portion 114 has a retractable rod 1141 connected to the swing arm 153. In practice, through the stretch or retraction actions of the retractable rod 1141, the driving portion 114 can drive the swing arm 153 to rotate around the axis portion 113 as an axial center thereby bringing the pre-heating board 151 of the pre-heater 15 away from the non-machined face 42 of the sandwiched core-paper 4 to facilitate convenient replenishment or alternation operations of the sandwiched core-paper 4 for handy operations.

The pre-heater 15 comprising the suspension arm 152 or swing arm 153 connected to the base 11 on the other side of the pre-heating board 151 indicates simply a preferred embodiment of the present invention; the pre-heater 15 may be also independently configured (not being connected to the base 11) so long as the pre-heater 15 is located on the input side 111 of the base 11, thus the scope of the present invention is by no means limited thereto. As such, it should be noticed that other modifications and equivalently structural alternations are all included within the scope of the present invention.

In practice, the production equipment for corrugated paper according to the present invention provides the following advantages:

1.A pre-heater 15 is installed on a input side 111 of a base 11 such that it is possible to perform the pre-heating operation to a sandwiched core-paper 4 by means of a pre-heating board 151 in the pre-heater 15 before heating lining paper 2, a paper material 3 and sandwiched core-paper 4 by a heating tool 16, so the speed for solidification and bonding between glue layers 5 of the paper material 3 and the sandwiched core-paper 4 can be effectively accelerated through the temperature contained in itself thereby lessening the installation costs and power consumption costs in certain heating boards 162 and further reducing the total manufacturing costs of corrugated paper;

2. Through the stretch or retraction actions of a retractable rod 1141, a driving portion 114 can drive a swing arm 153 to rotate around the axis portion 113 as an axial center thereby bringing the pre-heating board 151 of the pre-heater 15 away from a non-machined face 42 of the sandwiched core-paper 4 to facilitate convenient replenishment or alternation operations of the sandwiched core-paper 4 for handy operations.

Accordingly, the descriptions set forth as above all illustrate simply the preferred embodiments of the present invention, rather than restricting the scope of the present invention thereto. Essentially, the present invention provides a production equipment for corrugated paper comprising a bonding device 1, wherein a pre-heater 15 is installed on a input side 111 of a base 11 in the bonding device 1 so a pre-heating board 151 of the pre-heater 15 can pre-heat sandwiched core-paper 4 such that, after lining paper 2, paper material 3 and sandwiched core-paper 4 have been squeezed and bonded in a space 14, the speed of solidification and bonding in glue layers 5 of the paper material 3 and the sandwiched core-paper 4 can be accelerated by means of the temperature contained in itself. Consequently, it should be noticed that all structures and devices capable of achieving the aforementioned effects are covered by the scope of the present invention, so all such modifications and equivalently structural changes reasonably fall within the scope of the present invention.

In summary, the production equipment for corrugated paper according to the present invention is capable of, in practice, achieving the aforementioned effects and objectives thus demonstrating the values thereof with regards to usefulness and innovation and fulfilling the requirements on patent applications, so the present application is herein submitted based on relevant regulations in order to legally protect the inventor's efforts for the present invention. Should there be any questions or instructions from the examiners of your Office, the inventor of the present invention will be very glad to cooperate and provide any further information concerning the present application in details.

What is claimed is:

1. A production equipment for corrugated paper comprises a bonding device having a base, and a guiding assembly is installed in the base for guiding lining paper, a driving mechanism installed adjacent to the guiding assembly for driving the transfer of the lining paper, a paper material and sandwiched core-paper from a input side of the base, such that space can be created between the driving mechanism and the guiding assembly for mutually squeezing and bonding glue layers among the lining papers, paper material and sandwiched core-paper to form a paper board, wherein the glue layer on the lower surface of the paper material is attached to a non-machined face on one side of the sandwiched core-paper and the glue layer of a corrugated face on the other side of the sandwiched core-paper is attached to the upper surface of the lining papers, and a heating tool is installed on an output side of the base thereby heating the formed paper board so as to solidify the glue layers therein, characterized in that:
a pre-heater for heating the non-machined face of the sandwiched core-paper is installed on the input side of the base.

2. The production equipment for corrugated paper according to claim 1, wherein the guiding assembly includes a passive roller driven to rotate for attaching the lining paper, and a guiding portion is installed over the passive roller for guiding the lining paper to enter into the space, in which the driving mechanism includes a pressing roller adjacent to the guiding portion and driving the lining paper, paper material and sandwiched core-paper to pass through the space.

3. The production equipment for corrugated paper according to claim 1, wherein the heating tool includes a heating platform and a plurality of backward adjacently arranged heating boards are installed on the surface of the heating platform.

4. The production equipment for corrugated paper according to claim 1, wherein a pre-heating board attached to the non-machined face of the sandwiched core-paper is installed on one side of the pre-heater.

5. The production equipment for corrugated paper according to claim 4, wherein a suspension arm connected to the base is installed to the pre-heater on the other side opposite to the pre-heating board.

6. The production equipment for corrugated paper according to claim 4, wherein an L-shaped swing arm is installed to the pre-heater on the other side opposite to the pre-heating board, an axis portion pivotally connected for the swing arm to turn and bend is installed on one side of the base adjacent to the pre-heater, a driving portion is installed over the base, and a retractable rod is connected between the driving portion and the swing arm in order to drive the swing arm to rotate around the axis portion as an axial center through stretches and retractions thereby bringing the pre-heater away from the sandwiched core-paper.
